(19) United States
(12) Patent Application Publication
(10) Pub. No.: US 2015/0248295 A1
(43) Pub. Date: Sep. 3, 2015

(54) NUMERICAL STALL ANALYSIS OF CPU PERFORMANCE

(71) Applicant: QUALCOMM Incorporated, San Diego, CA (US)

(72) Inventors: Gerald Paul MICHALAK, Cary, NC (US); Alan G. SMITH, Cary, NC (US); Patrick J. GALIZIA, Cary, NC (US)

(73) Assignee: QUALCOMM Incorporated, San Diego, CA (US)

(21) Appl. No.: 14/195,783

(22) Filed: Mar. 3, 2014

(51) Int. Cl. G06F 9/38; G06F 11/30; G06F 11/34

(52) U.S. Cl. CPC G06F 9/3865; G06F 11/3409; G06F 11/3024

(57) ABSTRACT

A benchmarking mechanism numerically analyzing stalls in a pipelined CPU. Each stage in the CPU is instrumented with dedicated stall counters. For each clock cycle and for each CPU stage, the technology described herein determines whether the stage is stalled, counts the number of stalls per stage, determines why the stage is stalled, and determines which instruction is in the stalled processor stage along with its program address.

### TECHNICAL FIELD

Aspects of the present disclosure relate generally to processors, and more particularly to monitoring the performance of processors.

### BACKGROUND

Processors perform computational tasks in a wide variety of applications Improved processor performance is almost always desirable, to allow for faster operation and/or increased functionality.

To improve processor performance many modern processors employ a pipelined architecture, where sequential instructions, each having multiple execution steps, are overlapped in execution. For improved performance, the instructions should flow continuously through the pipeline. Any situation that causes instructions to stall in the pipeline can detrimentally influence performance.

One technique used to monitor and improve processor performance involves the use of a benchmarking scheme that measures the performance of a processor. Some conventional methods of determining processor performance use performance counters to gather indirect information regarding processor performance. Examples of performance counters are branch mispredict counters, Level 1 (L1) data cache miss counters, and the like. Performance counters, however, abstract away the micro-architecture stages and only provide indirect and aggregated clues as to the stalls.

Other performance monitoring techniques involve small, simple benchmarks so that manual examination is feasible. These smaller, simpler benchmarks can be non-representative of actual processor performance, however.

Larger benchmarks can be used on processors. These larger benchmarks contain millions of bytes of code and can take billions of clock cycles to execute. Moreover, when running large benchmarks on a complex processor it is very difficult to determine where the performance bottlenecks are. It is also very difficult to determine the relative impact of the bottlenecks on processor performance.

What is needed therefore is a mechanism to overcome these and other drawbacks.

### SUMMARY

Implementations of the technology disclosed herein are directed to methods, apparatuses, and non-transitory computer-readable media for numerically analyzing stalls in a pipelined processor. In one or more implementation, the technology includes a numerical stall analysis tool for analyzing stalls in a pipelined processor. The tool includes logic that that is configured to obtain instructions from one or more stages in the pipelined processor. The tool also includes counters that are configured to count a number of stalls by at least one of a pipeline stage, a stall type, and a program address for the stall. The tool also includes logic that is configured to provide the counted number of stalls to a performance monitoring system.

Alternative implementations include a method for numerically analyzing stalls in a pipelined processor. The method may operate by obtaining instructions from one or more stages in the pipelined processor, counting a number of stalls by at least one of a pipeline stage, a stall type, and a program address, and providing the counted number of stalls to a performance monitoring system.

A non-transitory computer-readable storage medium that includes data that, when accessed by a machine, may cause the machine to perform the operations comprising obtaining instructions from one or more stages in the pipelined processor, counting a number of stalls by at least one of a pipeline stage, a stall type, and a program address, and providing the counted number of stalls to a performance monitoring system.

Above is a simplified Summary relating to one or more implementations described herein. As such, the Summary should not be considered an extensive overview relating to all contemplated aspects and/or implementations, nor should the Summary be regarded to identify key or critical elements relating to all contemplated aspects and/or implementations or to delineate the scope associated with any particular aspect and/or implementation. Accordingly, the Summary has the sole purpose of presenting certain concepts relating to one or more aspects and/or implementations relating to the mechanisms disclosed herein in a simplified form to precede the detailed description presented below.

### BRIEF DESCRIPTION OF THE DRAWINGS

The accompanying drawings are presented to aid in the description of the technology described herein and are provided solely for illustration of the implementations and not limitation thereof.

FIG. 1 is a high-level block diagram of a processor according to one or more implementations of the technology described herein.

FIG. 2 is a high-level block diagram illustrating extraction of stall information according to one or more implementations of the technology described herein.

FIG. 3 is a graphical representation illustrating example counts of the number stalls by processor pipeline stage according to one or more implementations of the technology described herein.

FIG. 4 is a graphical representation illustrating example counts of the number stalls by type of stall according to one or more implementations of the technology described herein.

FIG. 5 is a graphical representation illustrating example counts of the number stalls by program/code address according to one or more implementations of the technology described herein.

FIGS. 6A-6C are diagrams illustrating example techniques for implementing the technology described herein.

FIG. 7 is a high-level schematic diagram of stall counter hardware according to one or more implementations of the technology described herein.

FIG. 8 illustrates a processor stage stall according to one or more implementations of the technology described herein.

FIG. 9 is a flowchart of a method illustrating operation of a processor numerical stall analysis tool according to an example implementation.

### DETAILED DESCRIPTION

In general, the subject matter disclosed herein is directed to systems, methods, apparatuses, and computer-readable media for numerically analyzing stalls in a pipelined CPU. In one or more implementations of the technology described herein, each stage in the CPU is instrumented with dedicated stall counters. For each clock cycle and for each CPU stage, the technology described herein determines whether the stage is stalled, counts the number of stalls per stage, determines why the stage is stalled, and determines which instruction is in the stalled CPU stage along with its program address. Stages may include a fetch stage, a decode stage, an execute stage, an access stage, a commit stage, and a write back stage.

The numerical analysis tool described herein provides a significant step forward in processor analysis and design by identifying and numerically quantifying the CPU stalls when running a benchmark. The numerical analysis tool described herein can be implemented in a simulation environment, an emulation environment, and/or a silicon environment. One benefit provided to enabling a shorter CPU design cycle and higher performing processor by providing focused information on performance bottlenecks. Also, the automated tooling in the benchmark enables clearing, starting, stopping, and reading the stall counters.

### Terminology

As used herein, the term “stalled” is intended to mean that on a given processor cycle, a pipeline stage contains a valid instruction, the downstream pipeline stage is available, and the instruction does not advance to the downstream stage. That is, a stall as defined herein occurs if the instruction could have moved forward because the stage in front of it is empty but the instruction does not move forward, it is termed a stall. For example, suppose that an instruction cannot move on because, for example, one of the instruction's operands presents a read-after-write (RAW) data hazard. The instruction following the instruction containing the read-after-write (RAW) data hazard cannot move on either, but is not considered stalled, since the downstream pipeline stage is occupied with the stalled instruction containing the read-after-write (RAW) data hazard and is not available. Some stalls may be expected and planned for a given processor microarchitecture. One or more other stalls may be stalls that are a sign of a bottleneck in the pipeline that needs to resolve in software and/or the hardware microarchitecture.

### Example Processor Environment

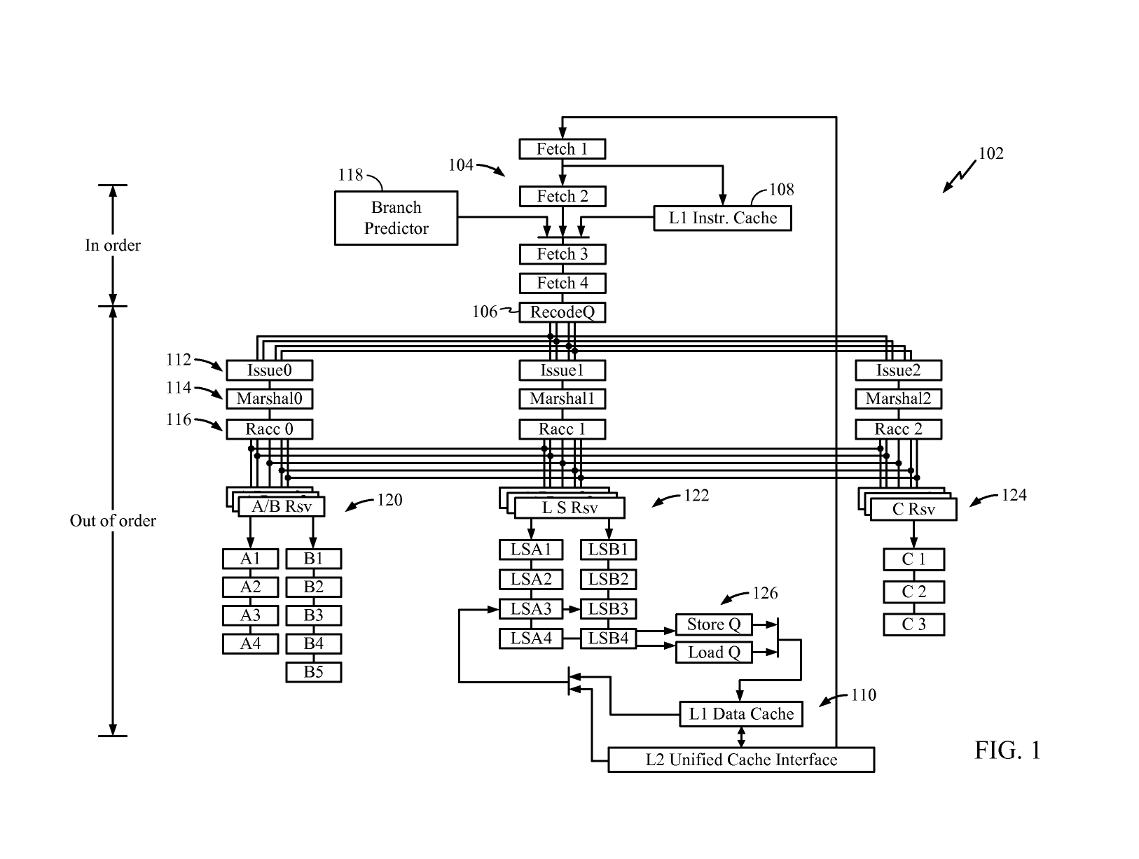

FIG. 1 is a high-level block diagram of a central processing unit (CPU) platform 102 according to one or more implementations of the technology described herein. The illustrated CPU platform 102 includes instruction fetch logic 104, recode queue logic 106, Level 1 (L1) instruction cache logic 108, Level 1 (L1) data cache and Level 2 (L2) unified cache interface logic 110, issue logic 112, marshal logic 114, access logic 116, and a branch predictor 118. The illustrated CPU platform 102 also includes logic 120, logic 122, 124, and store/load queue logic 126.

In one or more implementations, the logic 120 may be a compute pipeline. For example, the logic 102 may handle adds, multiplies, and other computing instructions in the central processing unit (CPU) platform 102.

In one or more implementations, the logic 122 may be a load and store pipeline. For example, the logic 122 may read in data into the memory hierarchy of the central processing unit (CPU) platform 102 and writes out data to the memory hierarchy of the central processing unit (CPU) platform 102.

In one or more implementations, the logic 124 also may be a compute pipeline that may handle adds, multiplies, and other computing instructions in the central processing unit (CPU) platform 102.

### Example Operation of Numerical Stall Analysis of CPU Performance

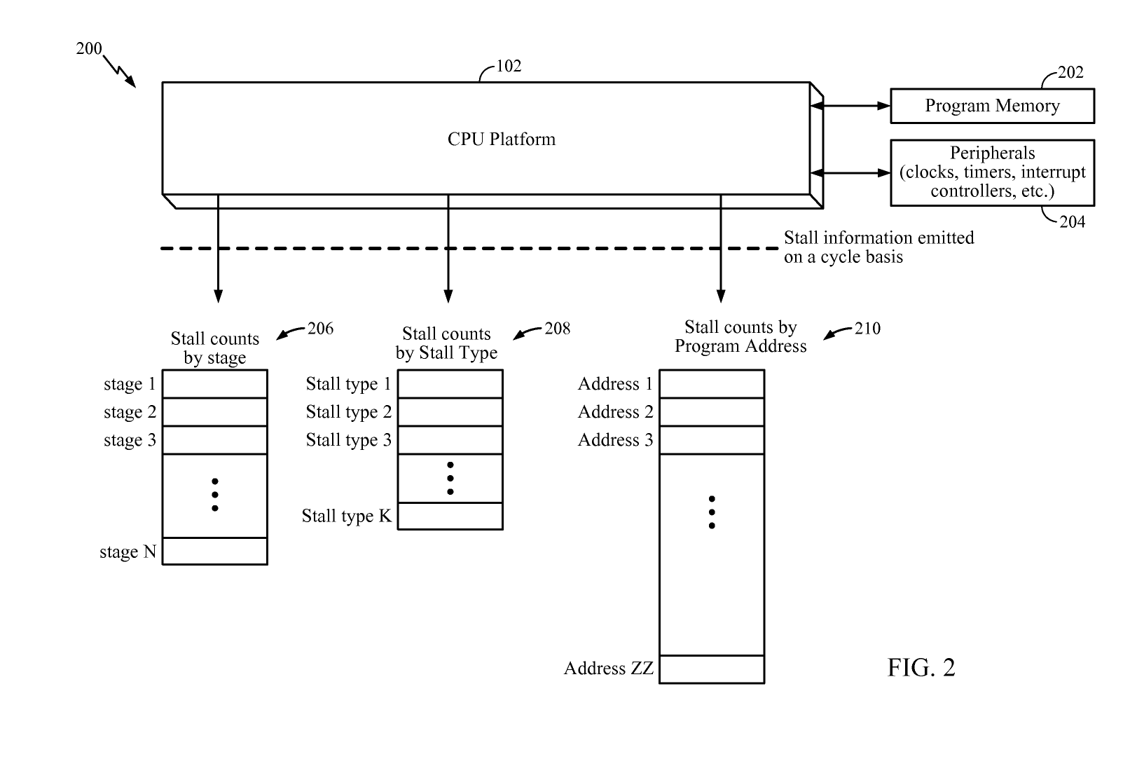

FIG. 2 is a high-level block diagram illustrating extraction of stall information according to one or more implementations of the technology described herein. The illustrated diagram includes the CPU platform 102, program memory 202, and peripherals 204.

Extraction of stall information from the illustrated CPU platform 102 may result in a number of stall counts by stage (206) in the CPU platform 102 pipeline. In this implementation, there are hardware counters in the CPU platform 102 that count the stages in the pipeline where stalls are occurring in the pipeline. The stages can be the fetch stages, decode stages, execution stages, branch prediction stage, dispatching stages, and so forth. One advantage of counting stalls by stage is that a processor microarchitecture designer can take a look at the processor that is being designed, note the number of stalls at particular stages, and use this information to optimize the design.

Extraction of stall information from the illustrated CPU platform 102 may result in a number of stall counts by stall type (208). The types of stalls can be read-after-write (RAW), write-after-read (WAR), cache miss, write back, and so forth. Additionally, stalls could be caused by waiting for conditional flags to be set. These stalls may be counted as well. One advantage of counting stalls by type is that a processor microarchitecture designer can take a look at the processor that is being designed, note the number of particular types of stalls, and use this information to optimize the design.

Extraction of stall information from the illustrated CPU platform 102 may result in a number of stall counts by program address (210) of the instruction. One advantage of counting stalls by program address is that a software developer can take a look at the application that is being designed, note the number of stalls at a particular program address, and use this information to optimize the design.

### Stalls by Pipeline Stage

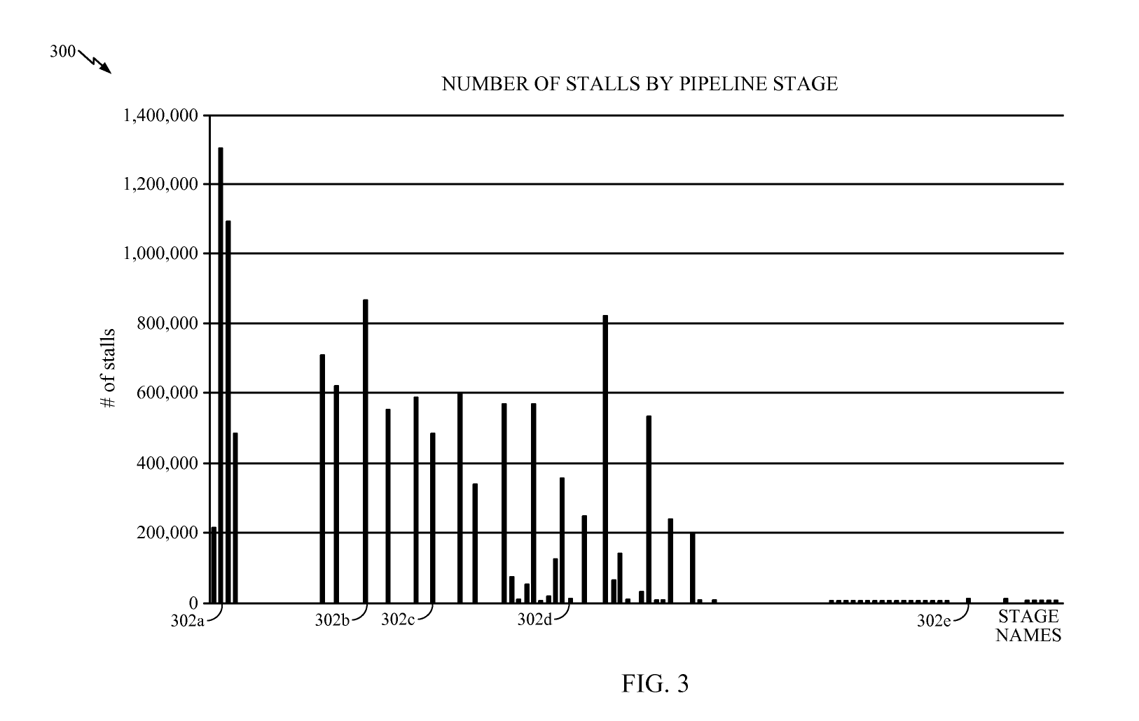

FIG. 3 is a graphical representation 300 illustrating example counts of the number stalls by processor pipeline stage (206) according to one or more implementations of the technology described herein. The illustrated graphical representation 300 includes an x-axis indicating pipeline stage names and a y-axis indicating a number of stalls.

In the illustrated implementation, at a stage 302a the counters count approximately 1,300,000 stalls, at a stage 302b the counters count approximately 900,000 stalls, and at a stage 302c the counters count approximately 500,000 stalls. At a stage 302d and a stage 302e, the stall count by stage is much lower than 200,000 stalls.

The stages 302a, 302b, 302c, 302d, and/or 302e can be the fetch stages, decode stages, execution stages, branch prediction stage, dispatching stages, and so forth. One advantage of counting stalls by stage is that a processor microarchitecture designer can take a look at the processor that is being designed, note the number of stalls at the stages The stages can be the fetch stages, decode stages, execution stages, branch prediction stage, dispatching stages, and so forth.

A stall in a stage may be a sign of a bottleneck in the pipeline that needs to be resolved in software and/or in the hardware microarchitecture. One advantage of counting stalls by stage is that a processor microarchitecture designer can take a look at the processor that is being designed, note the number of stalls at particular stages, and use this information to optimize the design of the CPU platform. Additionally, a software developer may use this information to fine tune the software being developed.

### Stalls by Stall Type

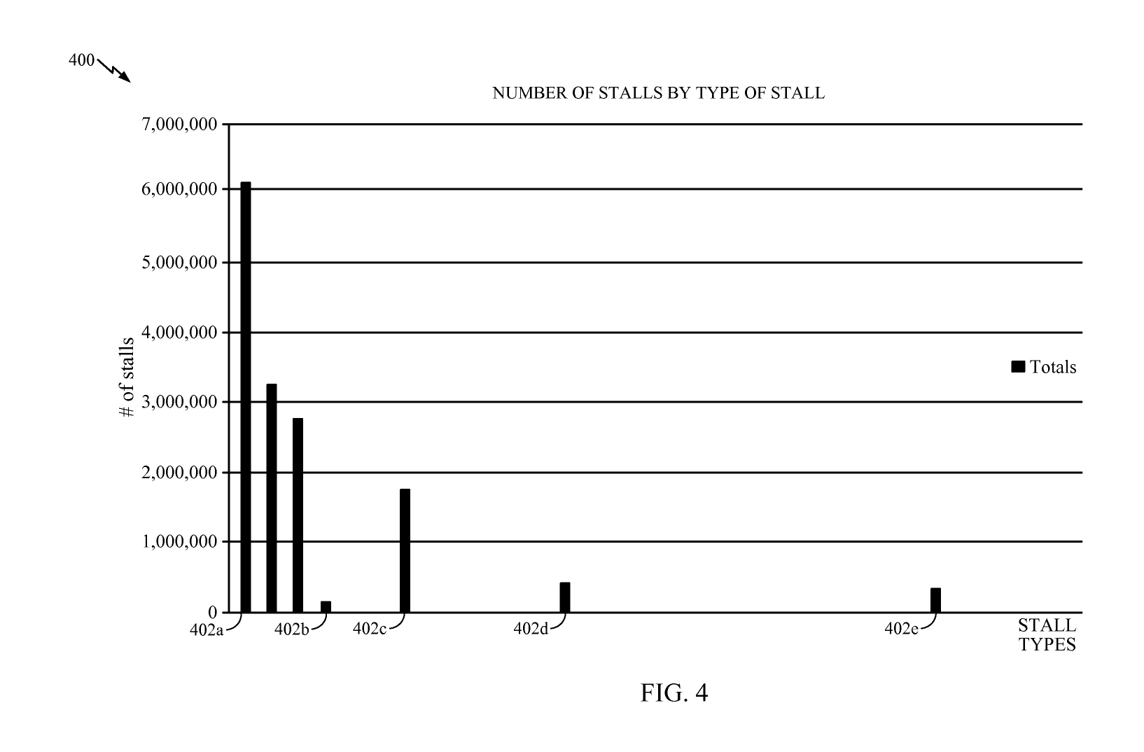

FIG. 4 is a graphical representation 400 illustrating example counts of the number stalls by type of stall (208) according to one or more implementations of the technology described herein. The illustrated graphical representation 400 includes an x-axis indicating stall types and a y-axis indicating a number of stalls. Stall types can include read-after-write (RAW) stalls, a write-after-read (WAR) stalls, cache “miss” stalls, and the like.

In the illustrated implementation, the counters count approximately 600,000 stalls that are a type 402a, just a few stalls that are a type 402b, approximately 175,000 stalls that are a type 402c, and approximately 50,000 stalls that are a type 402d and a type 402e.

The types of stalls 402a, 402b, 402c, 402d, and/or 402e can be read-after-write (RAW), write-after-read (WAR), cache miss, write back, branch misprediction, and so forth. Additionally, stalls could be caused by waiting for conditional flags to be set. Further, the type of stall may be undetermined. These stalls may be counted as well. Of course, this list stall types is not exhaustive, and after reading the description herein one could readily implement the disclosed technology for other stall types.

A stall in a stage may be a sign of a bottleneck in the pipeline that needs to be resolved in software and/or in the hardware microarchitecture. One advantage of counting stalls by type is that a processor microarchitecture designer can take a look at the processor that is being designed, note the number of stalls at particular stages, and use this information to optimize the design of the CPU platform. Additionally, a software developer may use this information to fine tune the software being developed.

### Stalls by Program/Code Address

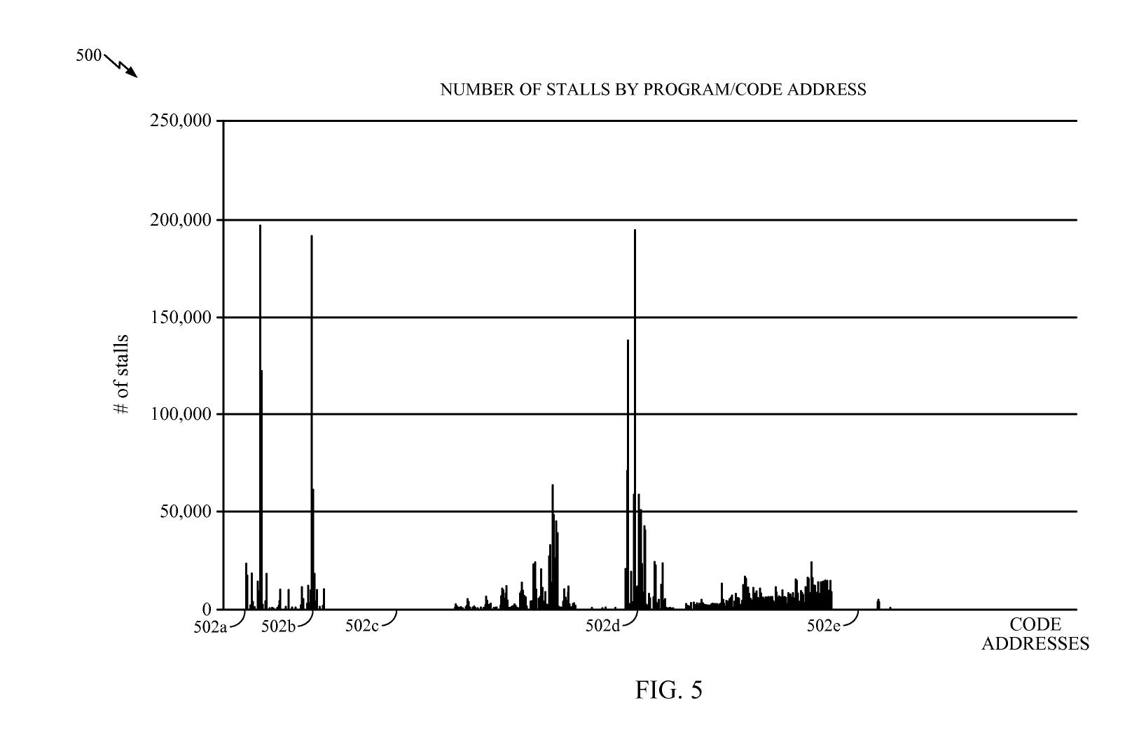

FIG. 5 is a graphical representation 500 illustrating example counts of the number stalls by program/code address according to one or more implementations of the technology described herein. The illustrated graphical representation 500 includes an x-axis indicating code addresses and a y-axis indicating a number of stalls.

The illustrated implementation shows that approximately 50,000 stalls have occurred at a program address 502a, approximately 175,000 stalls have occurred at a program address 502b, little or no stalls have occurred at a program address 502c, approximately 100,000 stalls have occurred at a program address 502d, and little or no stalls have occurred at a program address 502e program address.

A stall at a program address may be a sign of a bottleneck in the pipeline that needs to be resolved in software and/or in the hardware microarchitecture. One advantage of counting stalls by program address is that a processor microarchitecture designer can take a look at the processor that is being designed, note the number of stalls at a particular program address, and use this information to optimize the design of the CPU platform. Additionally, a software developer may use this information to fine tune the software being developed.

### Example Implementations in Simulated CPU, Emulated CPU (e.g., FPGA), and Silicon

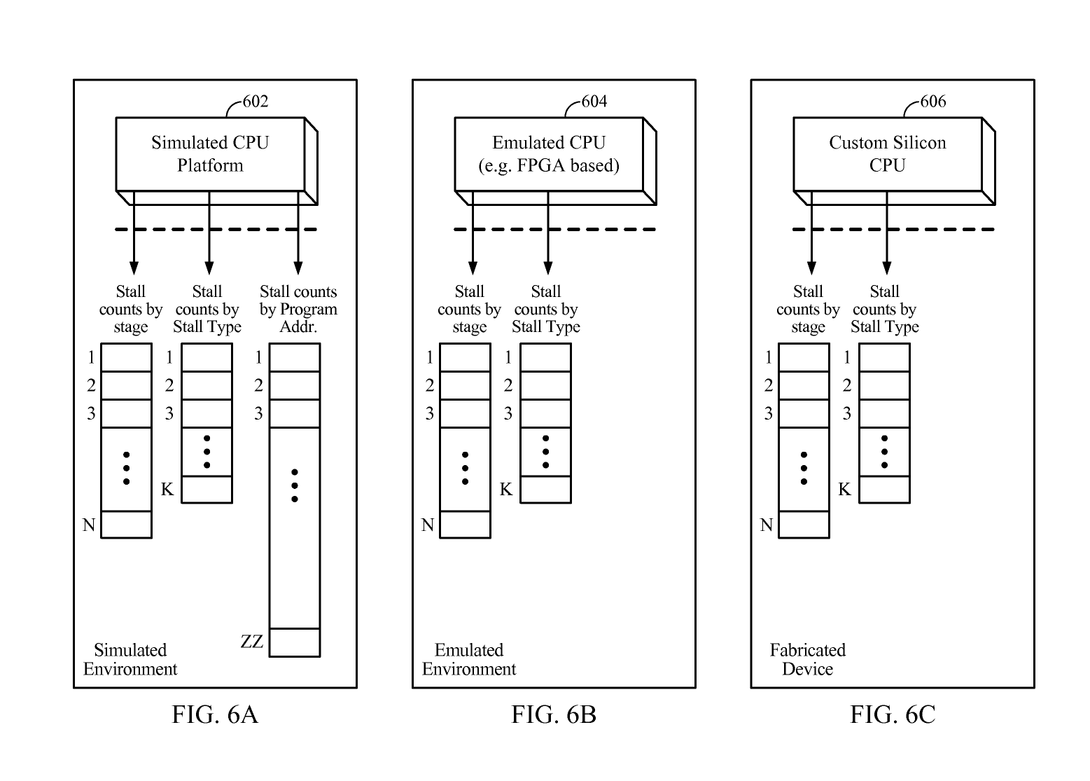

FIGS. 6A-6B are diagrams illustrating example techniques for implementing the technology described herein. In FIG. 6A, numerical stall analysis of CPU performance is illustrated as being implemented on a simulated CPU platform 602. For example, the simulated CPU platform could be a cycle-aware software simulation of the CPU microarchitecture that is created and analyzed before the CPU platform hardware is created. In this scenario, stalls by stage, type, and program address are counted and analyzed.

In FIG. 6B, numerical stall analysis of CPU performance is illustrated as being implemented on an emulated CPU platform 604, such as a field programmable gate array (FPGA). In this scenario, stalls by stage and type are counted and analyzed.

In FIG. 6C, numerical stall analysis of CPU performance is illustrated as being implemented in a custom silicon CPU platform 604, such as a custom integrated circuit and/or fabricated device. In this scenario, stalls by stage and type are counted and analyzed. Of course, implementation of the numerical stall analysis of CPU performance mechanism is not limited to a particular environment or fabricated device, and can be implemented in any one or all of the environments.

A representative progression in the design of a particular CPU design over time is given by FIGS. 6A to 6C, where the design is first realized by a cycle-aware software simulator, then moves to an FPGA-based implementation, and then moves to fabricated silicon. The first two types of counters (stall count by stage and stall count by stall type) have a limited number of entries determined by the processor design. As such, the amount of logic and memory used to implement these counters may be finite and may reasonably be accommodated at all stages of the design, including a software simulator, an emulated environment, and the fabricated silicon device.

For the third type of stall counter (stalls by program code/address), the amount of logic and logic counters needed may be determined by the program size and can be relatively large.

For the software simulator (FIG. 6A) and the emulated environment (FIG. 6B), some or all of the stalls by program code/address may be accommodated since these environments have a relatively high amount of resources, and the stalls by program code/address logic and associated counters will not place a burden on the final fabricated silicon processor. The stalls by program code/address logic and associated counters in the fabricated silicon processor may be implemented using a set of counters that do not cover all program addresses, but rather just covering a subset of all possible program addresses, e.g. most frequently stalled addresses.

For a high volume (of units produced) processor, it is also possible to create two versions of the processor, one with the stalls by program code/address logic and associated counters implemented and one version of the processor without the stalls by program code/address logic and associated counters. This will enable a larger version of the design to be used for performance analysis, while some (or most) implementations of the CPU design are available without the additional stalls by program code/address logic and associated counters.

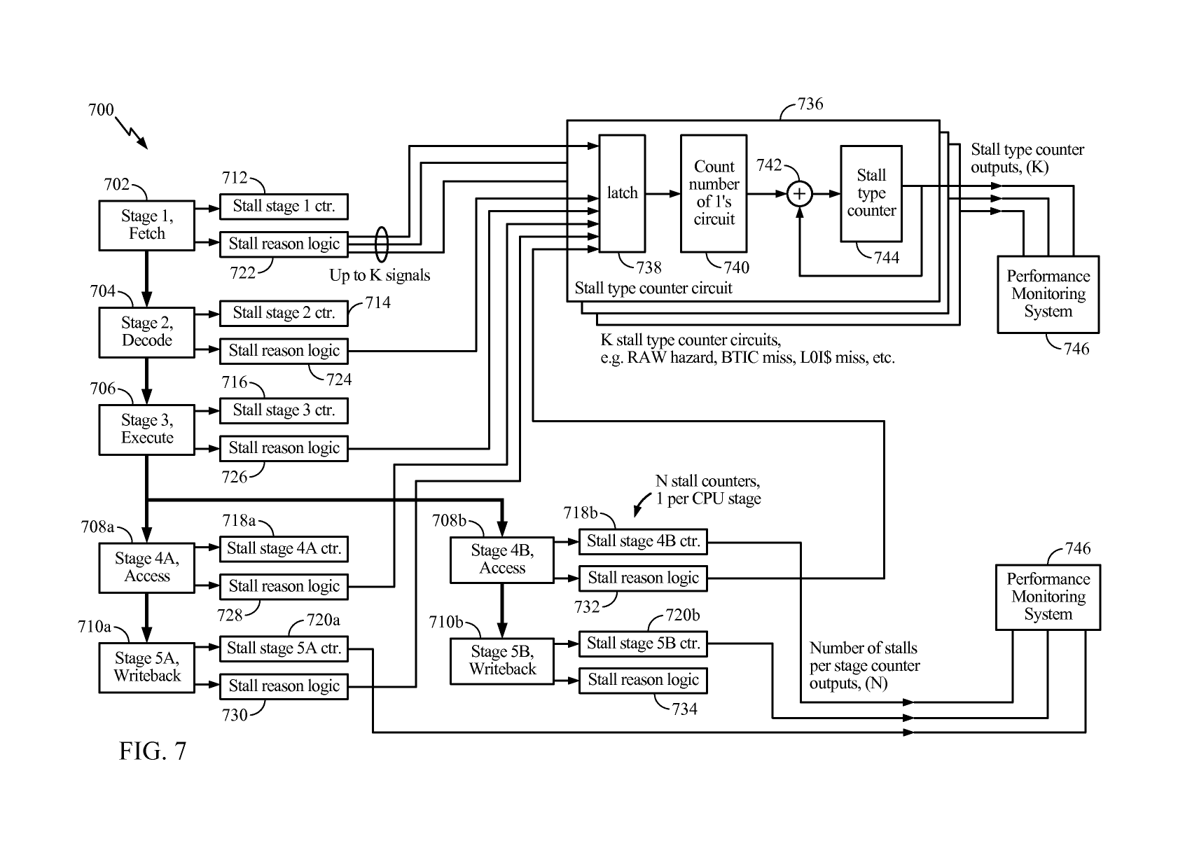

FIG. 7 is a high-level schematic diagram of stall counter hardware 700 according to one or more implementations of the technology described herein. Note that for purposes of clarity not all signals included in the stall counter hardware 700 are shown. Signals that are shown are representative of the total set of signals implemented.

The illustrated stall counter hardware 700 includes a stage 1 (fetch stage 702), a stage 2 (decode stage 704), a stage 3 (execute stage 706), a stage 4A (access stage 708a), a stage 4B (access stage 708b), a stage 5A (write back stage 710a), and a stage 5B (write back stage 710b).

In one or more implementations, fetch stage 702 may obtain instructions from instruction cache 108 and/or the CPU platform 102 memory (not shown). In one or more implementations, the decode stage 704 decodes obtained instructions, and the execute stage 706 executes the decoded obtained instructions.

In one or more implementations, the access stages 708a, 708b may read instruction operands from a register file (not shown). For example, an ADD instruction may read (i.e., access) two inputs from the register file.

In one or more implementations, the writeback stages 710a, 710b may write the results into the register file.

In the illustrated implementation, the fetch stage 702 is coupled to a stall stage 1 counter 712. The stall stage 1 counter 712 may count the number of stalls in the fetch stage 702 and output the count to a performance monitoring system 746.

In the illustrated implementation, the decode stage 704 is coupled to a stall stage 2 counter 714. The stall stage 2 counter 714 may count the number of stalls in the decode stage 704 and output the count to a performance monitoring system 746.

In the illustrated implementation, the execute stage 706 is coupled to a stall stage 3 counter 716. The stall stage 3 counter 716 may count the number of stalls in the execute stage 706 and output the count to a performance monitoring system 746.

In the illustrated implementation, the access stage 708a is coupled to a stall stage 4A counter 718a. The stall stage 4A counter 718a may count the number of stalls in the access stage 708a and output the count to a performance monitoring system 746.

In the illustrated implementation, the access stage 708b is coupled to a stall stage 4B counter 718b. The stall stage 4B counter 718b may count the number of stalls in the access stage 708b and output the count to a performance monitoring system 746.

In the illustrated implementation, the writeback stage 710a is coupled to a stall stage 5A counter 720a. The stall stage 5A counter 720a may count the number of stalls in the writeback stage 710a and output the count to a performance monitoring system 746.

In the illustrated implementation, the writeback stage 710b is coupled to a stall stage 5B counter 720b. The stall stage 5B counter 720b may count the number of stalls in the writeback stage 710b and output the count to a performance monitoring system 746. Of course, this list of pipeline stages is not exhaustive, and after reading the description herein one could readily implement the disclosed technology for other CPU pipeline stages.

In the illustrated implementation, the fetch stage 702 is coupled to stall reason logic 722, the decode stage 704 is coupled to stall reason logic 724, the execution stage 706 is coupled to stall reason logic 726, the access stage 708a is coupled to stall reason logic 728, access stage 708b is coupled to stall reason logic 732, writeback stage 710a is coupled to stall reason logic 730, access stage 708b is coupled to stall reason logic 732, and writeback stage 710b is coupled to stall reason logic 734. Stall reason logic 722, 724, 726, 728, 730, 732, and 734 may determine a type of stall that is counted in their respective stages. In one or more implementations, the stall reason logic 722, 724, 726, 728, 730, 732, and 734 is closely coupled with the processor stages 702, 704, 706, 708a, 708b, 710a, and 710b, and will use conditions (signals) associated with the processor stage to determine which of the few possible reasons for a stall is the actual stall reason on a given processor stall on a given processor cycle.

In the illustrated implementation, the stall reason logic 722, 724, 726, 728, 730, 732, and 734 are coupled to stall type counter logic 736. The illustrated stall type counter logic 736 includes a latch 738, a count number of “ones” circuit 740, a summer 742, and a stall type counter 744. In one or more implementations, on a given processor cycle, both access stage 708a and access stage 708b may encounter a stall due to a read-after-write (RAW) hazard. In this case, both stages 708a and 708b would assert a signal to the read-after-write (RAW) stall type counter circuit 736. The read-after-write (RAW) stall type counter circuit will latch both signals using latch 738, count the number of “ones: using count number of “ones” circuit 740, sum the signals using summer 742 (sum is two in this example), and add that count to the previous stall type counter value using stall type counter 744. It is to be understood that there may be separate stall type counter logic 736 for each type of stall (i.e., a separate stall type counter logic 736 for RAW stalls, cache miss stalls, etc.). The outputs of the individual stall type counter logic 736 are coupled to the performance monitoring system 746.

In one or more implementations, the performance monitoring system 746 may make the stall information available for further analysis and processing. For example, further analysis and processing may include creating text-based stall tables, creating graphs, or creating bar charts intended for analysis by a designer.

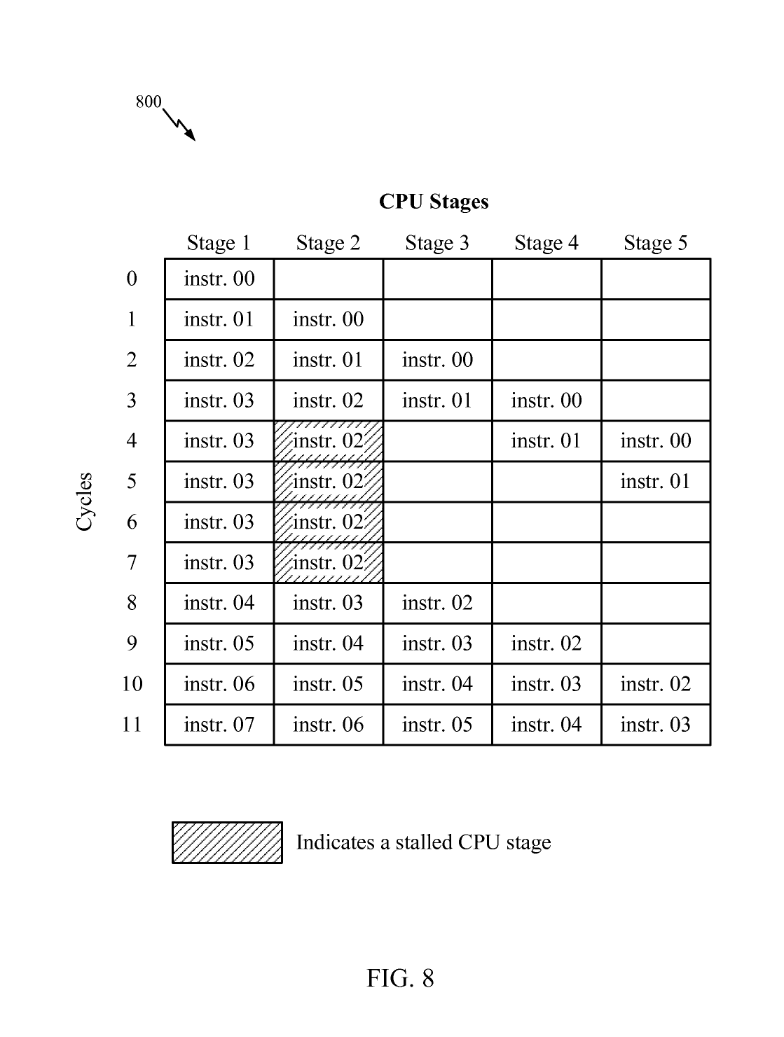

FIG. 8 is a table 800 illustrating processor stalls by stage according to one or more implementations of the technology described herein. In the illustrated implementation, instruction 02 has stalled at stage 2 and is stalled from clock cycle 4 to clock cycle 8. Instruction 2 is a valid instruction, the downstream pipeline stage 3 is valid (empty), and instruction 2 does not advance to downstream stage 3 on clock cycle 4. These stalls may be a sign of a bottleneck in the pipeline that needs to be resolved in software and/or the hardware microarchitecture in order to improve processor performance.

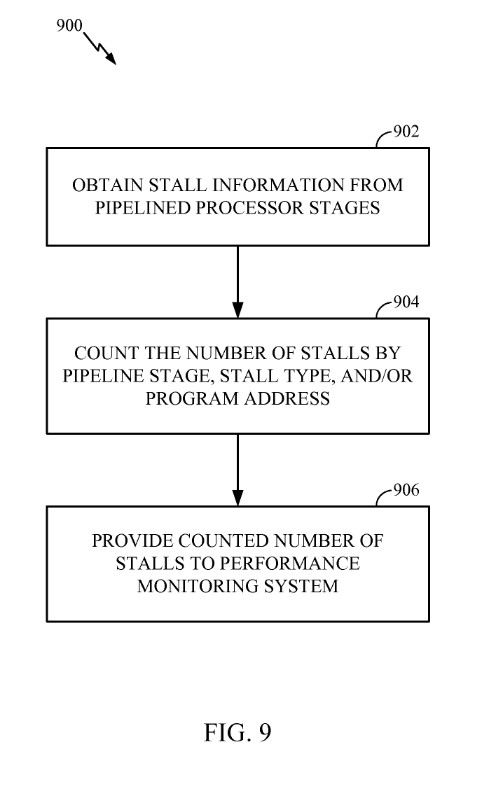

FIG. 9 is a flowchart of a method 900 illustrating operation of a processor numerical stall analysis tool according to an example implementation. In a block 902, the method 900 obtains stall information from pipelined processor stages. In a block 904, the method 904 counts the number of stalls by pipeline stage, stall type, and/or program address. The method 900 may place the results in output registers for access by a performance monitoring system. In a block 906, the method 900 provides the counted number of stalls to a performance monitoring system for analysis.

Aspects of the technology described herein are disclosed in the following description and related drawings directed to specific implementations of the technology described herein. Alternative implementations may be devised without departing from the scope of the technology described herein. Additionally, well-known elements of the technology described herein will not be described in detail or will be omitted so as not to obscure the relevant details of the technology described herein.

The word “exemplary” is used herein to mean “serving as an example, instance, or illustration.” Any implementation described herein as “exemplary” is not necessarily to be construed as preferred or advantageous over other implementations. Likewise, the term “implementations of the technology described herein” does not require that all implementations of the technology described herein include the discussed feature, advantage, or mode of operation.

The terminology used herein is for the purpose of describing particular implementations only and is not intended to be limiting of implementations of the technology described herein. As used herein, the singular forms “a,” “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many implementations are described in terms of sequences of actions to be performed by, for example, elements of a computing device. It will be recognized that various actions described herein can be performed by specific circuits (e.g., application specific ICs (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the technology described herein may be embodied in a number of different forms, all of which have been contemplated to be within the scope of the claimed subject matter. In addition, for each of the implementations described herein, the corresponding form of any such implementations may be described herein as, for example, “logic configured to” perform the described action.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present technology described herein.

The methods, sequences, and/or algorithms described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an implementation of the technology described herein can include a computer-readable media embodying a method for selective renaming in a microprocessor. Accordingly, the technology described herein is not limited to illustrated examples and any means for performing the functionality described herein are included in implementations of the technology described herein.

While the foregoing disclosure shows illustrative implementations of the technology described herein, it should be noted that various changes and modifications could be made herein without departing from the scope of the technology described herein as defined by the appended claims. The functions, steps, and/or actions of the method claims in accordance with the implementations of the technology described herein need not be performed in any particular order. Furthermore, although elements of the technology described herein may be described or claimed in the singular, the plural is contemplated unless limitation to the singular is explicitly stated.

What is claimed is:

1. A numerical stall analysis tool for analyzing stalls in a pipelined processor, the tool comprising:
logic that is configured to obtain instructions from one or more stages in the pipelined processor;
counters that are configured to count a number of stalls by at least one of a pipeline stage, a stall type, and a program address for the stall; and
logic that is configured to provide the counted number of stalls to a performance monitoring system.

2. The numerical stall analysis tool of claim 1, wherein the one or more stages include at least one of a fetch stage, a decode stage, an execute stage, an access stage, a commit stage, and a write back stage.

3. The numerical stall analysis tool of claim 1, wherein the stall type includes at least one of a read-after-write (RAW) stall, a write-after-read (WAR) stall, and a cache “miss” stall.

4. The numerical stall analysis tool of claim 1, implemented in a simulated processor platform.

5. The numerical stall analysis tool of claim 1, implemented in an emulated processor.

6. The numerical stall analysis tool of claim 5, wherein the emulated processor is a field programmable gate array (FPGA).

7. The numerical stall analysis tool of claim 1, implemented in an integrated circuit.

8. The numerical stall analysis tool of claim 1, further comprising logic to at least one of clear, start, stop, and read the counters.

9. A method for numerically analyzing stalls in a pipelined processor, the method comprising:
obtaining instructions from one or more stages in the pipelined processor;
counting a number of stalls by at least one of a pipeline stage, a stall type, and a program address; and
providing the counted number of stalls to a performance monitoring system.

10. The method of claim 9, wherein the one or more stages include at least one of a fetch stage, a decode stage, an execute stage, an access stage, a commit stage, and a write back stage.

11. The method of claim 9, wherein the stall type includes at least one of a read-after-write (RAW) stall, a write-after-read (WAR) stall, and a cache “miss” stall.

12. The method of claim 9, implemented in a simulated processor platform.

13. The method of claim 9, implemented in an emulated processor.

14. The method of claim 13, wherein the emulated processor is a field programmable gate array (FPGA).

15. The method of claim 8, implemented in an integrated circuit.

16. The method of claim 8, further comprising at least one of starting and stopping of the counting.

17. A non-transitory computer-readable storage medium including data that, when accessed by a machine, cause the machine to perform operations comprising:
obtaining instructions from one or more stages in the pipelined processor;
counting a number of stalls by at least one of a pipeline stage, a stall type, and a program address; and
providing the counted number of stalls to a performance monitoring system.

18. The non-transitory computer-readable storage medium of claim 17, wherein the one or more stages include at least one of a fetch stage, a decode stage, an execute stage, an access stage, a commit stage, and a write back stage.

19. The non-transitory computer-readable storage medium of claim 17, wherein the stall type includes at least one of a read-after-write (RAW) stall, a write-after-read (WAR) stall, and a cache “miss” stall.

20. The non-transitory computer-readable storage medium of claim 17, implemented in a simulated processor platform.

21. The non-transitory computer-readable storage medium of claim 17, implemented in an emulated processor.

22. The non-transitory computer-readable storage medium of claim 21, wherein the emulated processor is a field programmable gate array (FPGA).

23. The non-transitory computer-readable storage medium of claim 17, implemented in an integrated circuit.

24. The non-transitory computer-readable storage medium of claim 17, further including data that, when accessed by the machine, cause the machine to perform operations of at least one of starting and stopping of the counting.
